(19) United States
(12) Patent Application Publication
(10) Pub. No.: US 2008/0240140 A1
(43) Pub. Date: Oct. 2, 2008

(54) Network interface with receive classification

(75) Inventors: Alireza Dabagh, Kirkland, WA (US); Murari Sridharan, Sammamish, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 11/729,495

(22) Filed: Mar. 29, 2007

(51) Int. Cl. H04L 12/56

(52) U.S. Cl. 370/412; 370/389

(57) ABSTRACT

A network interface that provides improved processing of received packets in a networked computer by classifying packets as they are received. Further, both the characteristics used by the network interface to classify packets and the processing performed on those packets once classified may be programmed. The network interface contains multiple receive queues and one type of processing that may be performed is assigning packets to queues based on classification. A network stack within an operating system of the networked computer can route packets classified by the network interface to application level destinations with reduced processing. Additionally, the priority with which packets of certain classifications are processed may be used to allocate processing power to certain types of packets. As a specific example, a computer subjected to a particular type of denial of service attack sometimes called a “SYN attack” may lower the priority of processing SYN packets to reduce the effect of such an attack.

### BACKGROUND

Most computers have some form of network connectivity, which is provided by a combination of hardware and software elements. The computer is physically connected to a communication medium, such as a cable or a wireless medium, through a network interface. For example, a network interface card (NIC) acts as a network interface in many computers. The NIC participates in both transmit and receive operations. However, processing of received packets is frequently much more computationally intensive than transmitting packets.

As part of a receive operation, the NIC receives packets over the physical medium. As packets are received, they are buffered within the NIC and periodically transferred in blocks into system memory using a DMA process. The NIC then issues an indication that packets have been transferred into system memory.

A network stack within the operating system of the computer responds to the indication. By analyzing the data stored in the system memory, the stack determines an appropriate destination at the application level for the data in the received packets. For example, the data in a packet may be directed to a particular, client, virtual machine, transport, functional module or other application level component. Once the destination is identified, the network stack may place received data in an application buffer associated with the destination application and place a call on an interface supplied by that application, notifying the application that data is available.

The network stack determines the appropriate destination for data in a received packet by examining header information in the packets. The header information typically has a format dictated by a layered model used by networks such that the destination is specified by a combination of information at each of the networks layers. Accordingly, determining a destination for data in a packet requires the stack to process protocol identifiers at layer 2 (MAC address or VLAN IDs), layer 3 (IP address), layer 4 (TCP port numbers) and, in some cases, even higher layers.

Such processing can be a burden on the processor of a networked computer and, in some instances can be such a burden as to noticeably detract from performance of other functions by the networked computer. As a way to reduce the burden on the computer processor, some NICs are designed to perform the processing that is otherwise performed in the network stack. When the NIC implements these “stack offload functions,” the network stack, and the extensive processing it performs, can be bypassed.

However, a reason that processing in the network stack is computationally intensive is that proper delivery of one packet to its destination may depend on either previously or subsequently received packets. To facilitate delivery of packets in these circumstances, a network stack may maintain “state information” that represents the nature of the packets previously received. When stack offload functions are performed, the NIC must therefore maintain state information, which can make the NIC more complex.

### SUMMARY OF INVENTION

The load on a processor within a networked computer caused by processing received packets may be reduced by using a network interface configured to classify packets as they are received. The network interface may contain a collection of filters that may be programmed to identify packets of different classes based on header information. Further, the processing performed on each class of packets may be programmed for each class.

In some embodiments, the network interface contains one or more receive queues. The assignment of packets to queues may be programmed based on the classification assigned to the packets as they are received. The number of packets of each class that are assigned to a queue may also be programmed, such as by programming a limit on the number of packets pending in a queue. Packets received in excess of the limit may be dropped. The limit may be set as low as zero such that packets of a certain class may be blocked entirely.

Limiting the number of packets in each receive queue provides a mechanism to control use of processor resources and limits may be imposed when the networked computer determines that processing packets of a certain type would be disruptive. As one example, the effect of a type of denial of service attack, sometimes called a “SYN attack,” may be reduced by programming the network interface to classify and process SYN packets with a low priority.

Utilization of processor resources can also be controlled by programming the priority with which packets in the classified queues are indicated to an operating system.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch of a network environment in which embodiments of the invention may be employed;

FIG. 2 is a block diagram of a networked computer according to an embodiment of the invention;

FIG. 3 is a flow chart of a process of operating a networked computer according to an embodiment of the invention; and

FIG. 4 is a flow chart of processing a received packet in a network interface according to an embodiment of the invention;

### DETAILED DESCRIPTION

Processor resources in a networked computer may be more efficiently used by classifying received packets within a network interface. As a result, classification-based processing may be performed by the network interface without consuming processor resources. Classification-based processing may include dropping all packets of certain classes without indicating them to the operating system or limiting the number of packets of certain classes indicated to the operating system, thus reducing the amount of processor resources devoted to processing received packets. In addition, the classes may be prioritized, with packets being indicated to the operating system in accordance with their priority. When processor resources are limited, those resources will be preferentially allocated to higher priority packets.

Classification may be performed statelessly based on packet header information to limit the complexity of components added to the network interface to support classification. Nonetheless, the classification criteria may be programmable, providing flexibility to classify packets appropriately for a range of scenarios.

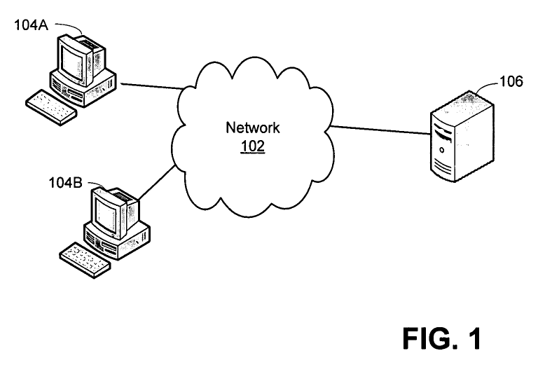

FIG. 1 illustrates a network environment in which embodiments of the invention may be employed. Networked computers 104A, 104B and 106 are shown connected to a network 102. In the example of FIG. 1, three networked computers are shown. However, a network may interconnect numerous networked computers of numerous types. Accordingly the number and type of networked computers attached to a network is not a limitation on the invention. The invention may be employed in a networked computer regardless of type or network size or configuration.

Network 102 may be any network through which networked computer devices may communicate. In the description that follows, it is assumed that network 102 is a packet switched network in which information is conveyed from one networked computer to another as a series of packets. Each packet contains header information that allows appropriate routing of each packet from its source to its intended destination.

Each of the networked computers makes a physical connection to network 102 through a network interface. The network interface allows the networked computer to receive packets transmitted over network 102. Hardware and software components within the networked computer determine whether the destination of the packet is within that networked computer.

In the embodiment illustrated, network 102 follows a multilayered network model in which information at different layers specifies different aspects of the destination device. For example, information at some layers in the network model may define a specific device that is the destination for the packet. Such information, for example, may allow networked computer 104A to distinguish between packets destined for it and packets destined for another network computing device, such as networked computer 104B.

Information at other layers of the network model may more particularly define how information in a received packet is to be used within a networked computer. For example, a networked computer may simultaneously run multiple application programs. Each application program may have one or more connections to applications on other networked computing devices. Proper processing of the received information requires associating that data with a connection of an application intended to receive it. Though, in some instances, operating system services and other operating components may be the destination for information in a received packet. Thus, in the examples that follow, received packets are classified based on an application to which the data is to be delivered or the manner in which an application will use the data. However, the invention is not limited to classifying packets destined for connections in application programs and may be employed with packets destined for an operating system service, another operating system component, a virtual machine or other destination.

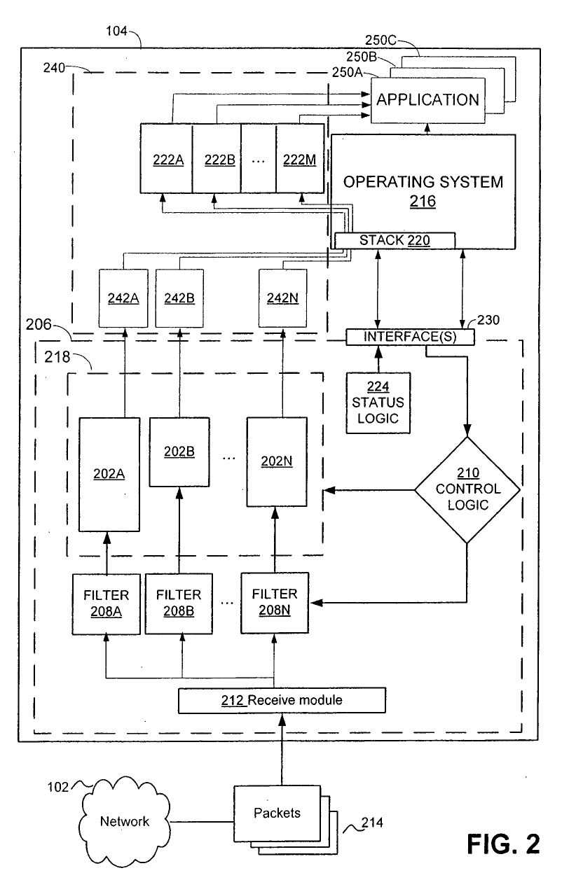

FIG. 2 shows an architectural block diagram of components within a networked computer that may process received packets. FIG. 2 illustrates a networked computer 104, which may represent any computing device connected to network 102. In operation, networked computer 104 may receive packets 214 over network 102 and process those packets.

Packets are received and first processed in a network interface, here illustrated as network interface card (NIC) 206. NIC 206 places data from received packets destined for application components within networked computer 104 into system memory 240. NIC 206 then indicates to stack 220 that data is available in system memory 240. Stack 220 may retrieve the data from system memory 240 and determine the destination for that data. Stack 220 may make the data available to its intended destination. In the example of FIG. 2 application programs 250A, 250B and 250C are shown as destinations for data received over network 102.

The basic flow of received data illustrated in FIG. 2 is the same as employed in known networked computers, passing first from a network interface card, then to system memory and then to a destination application. Accordingly, the components shown in FIG. 2 may generally be implemented using technology used in known networked computers. However, any suitable implementation may be used.

For example, receive module 212 receives packets over network 102 and selects for further processing only those having a destination within networked computer 104. The operations performed in receive module 212 are also performed in known network interface cards. Accordingly, received module 212 may be implemented using known technology or in any other suitable way.

Similarly, once stack 220 identifies the destination for data in a received packet, stack 220 places the data in an application buffer associated with the intended destination. In the example of FIG. 2, application buffers 222A, 222B . . . 222M are illustrated. Stack 220 places data from received packets in one of these application buffers and then notifies the destination application that data is available for it. This mechanism of delivering received data to an application is employed in known networked computers, and such mechanisms may be used to implement application buffers 222A, 222B . . . 222M and interface to applications 250A, 250B and 250C.

However, NIC 206 differs from a conventional network interface card in that it is adapted to classify packets as they are received and then process the data in the packets according to the classification. Accordingly, FIG. 2 shows that NIC 206 contains multiple classification filters 208A, 208B . . . 208N. Each of the classification filters may apply a collection of criteria and/or rules to an incoming packet. These rules and criteria determine whether the packet belongs to the class of packets the filter is programmed to identify. Thus, each classification filter outputs packets that belongs to a class, which is defined based on packet characteristics.

Once a packet is classified, the packet may be further processed based on that classification. Classification-based processing may be performed within NIC 206 and/or within operating system 216. In the embodiment illustrated, NIC 206 further process packets output by the classification filters by selectively assigning the packets to receive queues based on class. In the embodiment of FIG. 2, each classification filter 208A, 208B, . . . 208N is associated with a receive queue 202A, 202B, . . . 202N, respectively. Thus, processing may entail assigning each packet to a receive queue containing other packets of the same class. However, in other embodiments other processing may be performed on packets once classified.

Each of the classification filters 208A, 208B . . . 208N may be implemented in any suitable way. For example, NIC 206 may be implemented as part of a semiconductor chip having a section that may be programmed to perform logic functions. Each of the classification filters 208A, 208B . . . 208N may therefore be implemented by programming a segment of the semiconductor chip. In some embodiments, the semiconductor chip will be field programmable, allowing the classification criteria to be reprogrammed as networked computer operates or at any other suitable time. However, any suitable method of implementing classification filters may be used.

NIC 206 may also include memory 218. Memory 218 may be implemented as part of a semiconductor chip in which filters 202A, 202B . . . 202N are implemented, as part of a separate chip or in any other suitable way. Receive queues 202A, 202B . . . 202N may be formed by allocating locations in memory 218. Techniques to control the storage and retrieval of information within the memory to implement a queue are known. However, any suitable components may be used to create receive queues within memory 218.

NIC 206 also contains control logic 210. Control logic 210 may control the allocation of portions of memory 218 into separate receive queues 202A, 202B . . . 202N. Additionally, control logic 210 may control the specific filter criteria programmed into each of the classification filters 208A, 208B . . . 208N. The specific functions performed by control logic 210 may be controlled by commands from operating system 216 passed through interface 230.

Control logic 210 may be implemented using a portion of a semiconductor chip. In some embodiments, that semiconductor chip may be field programmable, allowing the specific functions performed by NIC 206 to be changed as networked computer 104 operates, or at any other suitable time. Further, the functions performed by control logic 210 may be controlled or implemented in whole or in part by a driver for NIC 206 or other software. Accordingly, the specific implementation of control logic 210 is not a limitation on the invention and control logic 210 may be implemented in any suitable way.

NIC 206 may also include status logic 224. As with control logic 210, status logic 224 may be implemented as part of a semiconductor chip used to implement NIC 206 either alone or in combination with a drive or other software. Status logic 224 provides information on the configuration or operation of NIC 206 to operating system 216.

Operating system 216 contains stack 220, similar to a network stack in a conventional networked computer. Though stack 220 is adapted for processing received packets that have been classified by NIC 206, the information passed from status logic 224 to stack 220 and commands passed from stack 220 to control logic 210 may be similar to the information and commands exchanged between a stack and logic within a network interface card in a conventional networked computer.

In the embodiment of FIG. 2, an interface 230 is shown between NIC 206 and operating system 216. Such an interface may be provided by a software driver associated with NIC 206. In a conventional networked computer, such a driver may provide one or more interfaces allowing for command and status information to be exchanged between an operating system and a network interface card. For example, interface 230 may contain an NDIS interface and IOCTL interface as are known in the art. The NDIS interface may allow for the exchange of information relating to the transmission or receipt of packets. The IOCTL interface may be used predominantly for exchange of status and control information. Because the IOCTL interface is intended to be expandable, programming of NIC 206 from operating system 216 may be achieved by passing one or more IOCTL command objects through interface 230. However, the specific mechanism by which NIC 206 is programmed is not a limitation on the invention.

Regardless of the specific mechanism by which NIC 206 is programmed, NIC 206 may be programmed to direct packets to separate receive queues 202A, 202B . . . 202N based on classification of those packets made in filters 208A, 208B . . . 208N. Data received in these packets may then be transferred for further processing by operating system 216, retaining the classification imposed by NIC 206. Accordingly, FIG. 2 shows that data from each of the receive queues 202A, 202B . . . 202N can be transferred to a corresponding receive buffer 242A, 242B . . . 242N within system memory 240.

The mechanism for transferring data between NIC 206 and system memory 240 may be the same as used in known networked computer. For example, a direct memory access (DMA) operation may be used to transfer data from each receive queue to each receive buffer. Though, the mechanism used to transfer is not a limitation on the invention and any suitable mechanism may be employed.

However, the data transfer from NIC 206 to system memory 240 differs from that in a conventional networked computer in that the data associated with each of the receive queues 202A, 202B . . . 202N may be transferred independently. The timing at which transfer from a receive queue to a receive buffer occurs may therefore be controlled by operation of NIC 206. Likewise, the destination for each transfer may also be specified independently.

Regardless of when and how data is transferred from receive queues 202A, 202B . . . 202N to receive buffers 242A, 242B . . . 242N, once data is transferred, status logic 224 may indicate to operating system 216 that data has been transferred. The indication may be performed similar to an indication made in a conventional network interface card. However, in addition to indicating that data has been transferred to system memory 240, the indication may identify one or more receive buffers 242A, 242B . . . 242N that has received data.

Once operating system 216 receives an indication that receive data is stored in system memory 240, stack 220 may process the data to deliver it to its destination. The processing performed by stack 220 may be generally similar to that in a conventional networked computer, resulting in data being transferred to one of the application buffers 222A, 222B . . . 222M associated with the application destined to receive the data. However, stack 220 may forego any processing required to obtain classification information supplied by the classification performed in NIC 206. Accordingly, processing within stack 220 may be simpler than is employed in a conventional networked computer.

For example, if classification filter 208A is programmed to pass packets directed to a single application, such as application 250A, stack 220 may, with little processing move data from receive buffer 242A to application buffer 222A and notify application 250A. In transferring data from receive buffer 242A to application buffer 222A, stack 220 may place the data in an appropriate order using state information or otherwise format the data. However, the processing required for such a transfer may be far less than is required for transferring data to a receive buffer to an application buffer in a conventional networked computer.

Though a reduction of processing performed by stack 220 is at the expense of increased processing in NIC 206, processing within NIC 206 may be based on header information. Accordingly, in the embodiment illustrated, NIC 206 does not maintain state information as part of packet classification. As a result, the components of NIC 206 that classify packets and separately store them based on classification in separate receive queues 202A, 202B . . . 202N is relatively simple.

Further, processing performed within operating system 216 including processing by stack 220, which is a component of operating system 216, is performed by a processor in networked computer 104. Frequently, the same processor resources that would otherwise be used to perform processing by application 250A, 250B or 250C are diverted for processing within operating system 216. In contrast, processing within NIC 206 does not consume processor resources that may have otherwise been available for execution of applications 250A, 250B and 250C. Consequently, processing within NIC 206 is less likely to create a perceptible performance impact in executing applications 250A, 250B and 250C, which would be observable to the a user of networked computer 104.

In addition to reducing the amount of processing, and its impact on execution of applications 250A, 250B and 250C, classification of packets within NIC 206 may facilitate other functions that are not possible with a conventional network interface card.

For example, the ability of NIC 206 to classify received packets may be employed to control the amount of processor resources devoted to processing each class of received packets. In scenarios in which the total amount of processor resources available for processing received packets is limited, those limited resources may be allocated for processing received packets most likely to impact the overall performance of networks computer 104. For example, packets destined for a multimedia application may be given a higher priority, because a user of networked computer 104 is more likely to perceive a performance problem with networked computer 104 if there are delays in processing multimedia data.

Conversely, received packets in certain classes may represent data that is unimportant or even a nuisance, making it undesirable to consume processor resources on those packets. As a specific example, such a scenario may arise if networked computer 104 is subjected to a type of denial of service attack sometimes referred to as a “SYN attack.” In a SYN attack, an attacker directs multiple SYN packets to networked computer 104. Each SYN packet represents a request to establish a connection, which requires a relatively large amount of processing within operating system 216. When a malicious third party directs a large number of SYN packets towards networked computer 104, so much of the processor resources of computer 104 may be diverted to responding to the SYN packets that insufficient resources are available for processing required by applications 250A, 250B and 250C. Accordingly, those application cease to function.

Because NIC 206 has the ability to classify packets, it may classify SYN packets for separate processing. Part of that processing may include limiting the number of SYN packets indicated to operating system 216, which would limit the damage caused by a SYN attack. Such limits could be imposed as part of an initial configuration of NIC 206. Alternatively, such limits could be imposed by monitoring the quantity of SYN packets received by network computer 104. Such monitoring could be performed within control logic 210 on NIC 206 or within operating system 216. Regardless of how the need for limiting SYN packets is detected, when an unacceptably large number of SYN packets is detected, limits on the number of SYN packets passed to operating system 216 may be imposed by reconfiguring NIC 206.

Alternatively, the affects of a SYN attack may also be reduced by prioritizing processing of received packets based on class. When a large number of SYN packets is detected, indicating the possibility of a SYN attack, the priority with which SYN packets are indicated to operating system 216 may be lowered. As a result, SYN packets would be processed within operating system 216 when operating system 216 is not busy processing data associated with other classes of packets. In this way, the effects of this SYN attack are reduced.

As another alternative, the number of packets of a particular class assigned to a receive queue may be limited as a way to reduce the processing burden for processing packets of that class. This approach may be used with SYN packets or other type of packets that may be used in a denial of service attack. The limit could be set higher than the number of SYN packets expected in normal operation of networked computer 104, but lower than the number of SYN packets expected as part of a denial of service attack. Such limits could be imposed even before a denial of service attack is detected. Accordingly, another type of class-based processing performed on the outputs of the classification filters 208A, 208B, . . . 208N may entail applying quantitative limits on the packets transferred to a receive queue.

In the embodiment illustrated, the quantitative limits may be programmed as a limit on the total number of packets that may be enqueued in a receive queue associated with the class. The number of packets may be set as low as zero, acting as a block on further processing of packets of a class. Though in some embodiments, a block may be directly set by indicating that all packets of a certain class should be dropped.

Class-based processing of packets similarly may be useful in other scenarios. For example, a defective device connected to network 102 may repeatedly transmit packets for a destination within networked computer 104. When such an operating condition is identified, one of the classification filters 208A, 208B . . . 208N could be programmed to segregate those packets so that they could be discarded without further processing. Accordingly, NIC 206 is adapted to be flexibly programmed to accommodate class-based processing in support of many functions.

NIC 206 may be programmed with commands sent through interface 230. Thus, processing within stack 220 or other component of operating system 216 may determine a configuration of NIC 206 that provides desirable operation. Though, in some embodiments, one or more of the applications 250A, 250B or 250C may either directly specify programming of NIC 206 or may provide input used by operating system 216 to determine an appropriate configuration into which to program NIC 206.

Commands in any suitable format may be used to program NIC 206 and the specific programming commands that NIC 206 receives is not a limitation of the invention. However, NIC 206 may be adapted to respond to commands that specify programming of classification filters.

In some embodiments, a classification filter is defined by the following classification parameters, which may be communicated in part by a programming command:
Header
Header Offset
Length
Pattern Bitmap
Pattern
Operation

The classification parameters generally define two types of information. The header, header offset, length and pattern bitmap parameters collectively define the portion of a packet header that is used for filtering packets. The pattern and operation parameters collectively indicate the data values within the selected portion of the packet header that will cause a packet to pass the filter.

The header parameter specifies the header in the packet from which bytes should be selected for examination by a classification filter. This parameter, in conjunction with the header offset parameter, is used to specify the first byte in the packet that should be selected for comparison to a pattern. As one example, the header parameter may take on one of the following values, identifying the different network layer headers that often appear in a packet transmitted over a network:
MAC header
IP Header
TCP header
UDP header
Upper layer protocol header

The header offset parameter specifies the offset into the header of the bytes that are to selected for comparison to the pattern.

The length parameter specifies the length of the data that should be selected.

The pattern bitmap parameter specifies which bytes in the received packet, starting with the byte determined by Header, Header Offset and Length parameters, should be used in comparison to the pattern. A set bit indicates a byte should be considered, a clear bit indicates a byte should be ignored.

The pattern parameters specify the data values to which the selected portion of a received packet will be compared.

The operation parameter defines the logical operation performed when comparing the selected portion of the received packet and the pattern to determine whether a received packet meets a classification criterion. As one example, the operation parameter could have one of the following values:
Match
Don't match
Within Range

Additionally, NIC 206 may be programmed to perform class-based processing. For example, NIC 206 could be programmed by providing a Queue Action parameter associated with each class. Such a parameter could specify an action taken on each packet when it is assigned to a class. These actions may be performed by hardware for NIC 206 or software, such as a NIC driver. For example, Queue Action parameters may specify actions that a NIC driver must perform on each queue. Queue Action parameter could be assigned one of the following values:
Indicate:
NIC driver should indicate packets in the queue specifying which queue they belong to.
Drop:
NIC driver must drop packets that meet the criteria for this queue.
Limit:
NIC driver must limit the number of packets that meet the criteria for this queue.

As another example of class-based processing, NIC 206 may be programmed with a Queue Priority. This parameter may dictate the order in which queues should be processed. NIC drivers may be adapted to indicate packets with a higher priority queue first.

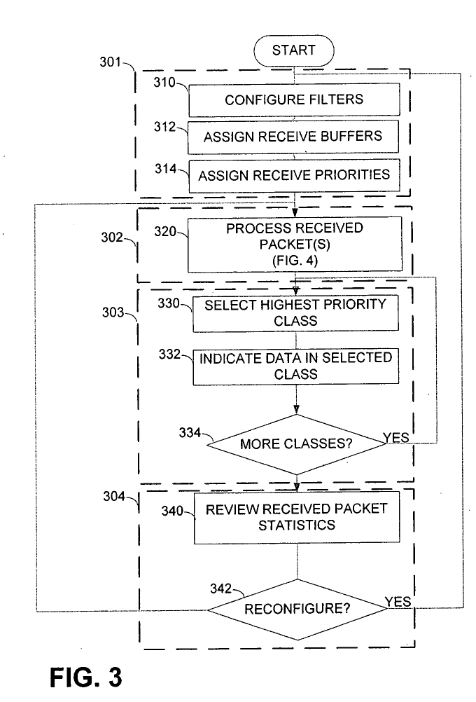

These capabilities may be used to program NIC 206 to efficiently process packets or perform other desired operations. FIG. 3 shows a process by which a networked computer, such as networked computer 104 (FIG. 2), may process packets according to an embodiment of the invention.

The flowchart of FIG. 3 illustrates four subprocesses. In subprocess 301, NIC 206 is programmed to classify received packets and to perform processing on the packets based on the assigned classes. In the subprocess 302, packets are received and processed according to the classifications that have been programmed into NIC 206.

Subprocess 303 involves transfer of received packets for further processing within the operating system of the network computer. Subprocess 304 involves analysis of information obtained as a result of classifying received packets. Following subprocess 304 one or more of the subprocesses may be repeated, so long as more packets are received.

The process illustrated in FIG. 3 begins at block 310, where configuration commands are issued to the NIC 206. As described above in connection with FIG. 2, programming commands may be transmitted through interface 230. However, the specific method by which a NIC is configured to classify received packets or to process packets once classified is not critical to the invention and any suitable method may be used.

Configuration of NIC 206 may entail specifying parameters that control classification by one or more filters. The values of the classification parameters programmed into each of these filters may depend on the applications 250A, 250B and 250C operating on networked computer 104 or other operating characteristics of the networked computer. Because some classes may be applicable to most or all networked computers, parameters configuring filters to recognize packets in those classes may be pre-stored within NIC 206 and processing at block 310 may not include expressly configuring filters to recognize packets in those classes. For example, it was described above that by programming a NIC to identify SYN packets, the damage caused by a SYN attack can be reduced. Accordingly, one filter in NIC 206 may be configured to segregate SYN packets into a separate class. Because such a filter may be useful in most or all networked computers, a network interface card may come preconfigured with a filter to identify SYN packets. In embodiments in which a filter is not preconfigured for segregating SYN packets, processing at block 310 may program a filter in NIC 206 to identify SYN packets when filters are programmed to recognize other classes of packets.

Having other classes may be desirable for other operations performed by the networked computer. For example, a networked computer may be configured to execute one or more virtual machines. A filter may be programmed to segregate received packets directed for each of the virtual machines. Segregating packets destined for virtual machines in this fashion may reduce processing load on stack 220 because stack 220 does not need to parse packets to identify those intended for each virtual machine. Still other filters may be defined to support other operations based on applications to be executed by the networked computer. Regardless and the number and type of classes of received packets to be recognized by NIC 206, parameters to program filters on NIC 206 to recognize each packet may programmed at block 310.

Related configurations may also be programmed at block 310. In the embodiment of FIG. 2, a receive queue is associated with each filter. Accordingly, configuring filters at block 310 may also entail configuring memory 218 to provide multiple receive queues, one associated with each filter established.

At block 312, receive buffers are assigned. In the embodiment of FIG. 2, receive buffers are formed in systems memory 240. The receive buffers may be formed at any suitable location, though both NIC 206 and operating system 216 should be aware of the location so that NIC 206 deposits data in the locations where operating system 216 will retrieve the data.

Though the specific locations at which receive buffers are formed is not critical to the invention, in some embodiments an advantage may be obtained by appropriate selection of memory locations for receive buffers 242A, 242B . . . 242N. For example, in a networked computer configured with multiple virtual machines, each virtual machine is typically allocated a certain address space in system memory 240. By filtering packets destined for each virtual machine into a separate class and assigning a receive buffer for each virtual machine in that virtual machine's address space, each virtual machine may more readily access data stored in its receive buffer.

The process of configuring NIC 206 continues at block 314. At block 314, a priority may be assigned to each class that NIC 206 is adapted to recognize. The manner in which priorities are assigned is not critical to the invention. However, in some embodiments, the priorities assigned at block 314 may be assigned based on the characteristics of the applications that are the destinations of the packets in each class.

For example, a higher priority may be assigned to classes containing packets that must be processed quickly, such as those carrying data used in multimedia or distributed computing applications. Conversely, a lower priority may be assigned to classes containing packets for which few processor resources are to be allocated.

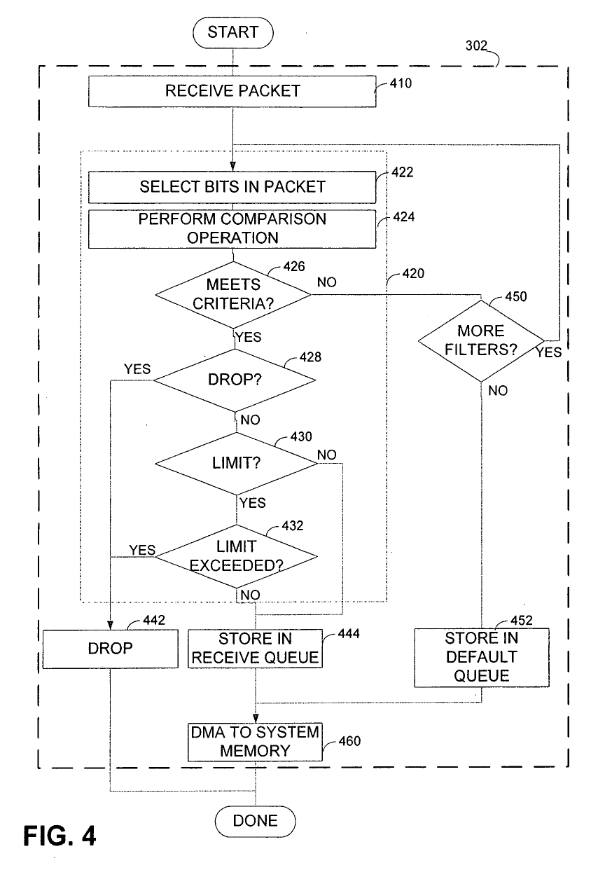

Once NIC 206 is configured in subprocess 301, received packets are processed in subproces 302. Accordingly, the process continues to block 320. At block 320, NIC 206 receives and processes packets according to the configuration established in subprocess 301. As described above in connection with FIG. 2, processing within the NIC involves classifying packets as they are received and storing packets in each class in a separate receive queue. More details of the processed steps performed as part of subprocess 302 are shown in conjunction with FIG. 4, below.

The process as shown in FIG. 3 continues to subprocess 302 at block 330, as described in more detail below in connection with FIG. 4. As described above in connection with FIG. 2, packets stored in receive queues 202A, 202B . . . 202N are transferred in a batch mode to receive buffers 242A, 242B . . . 242N, respectively. These transfers may be triggered by any suitable event. For example, the transfers may be made continuously as packets are received, so long as components within networked computer 104 are not in use for other operations. However, the trigger for transfers to system memory is not a limitation on the invention and any suitable trigger may be used.

A mechanism may be employed to notify operating system 216 that packets are available for processing. For example, the operating system may periodically interrupt the NIC 206 and place a deferred processor call on NIC 206. In response, NIC 206 may identify locations in system memory 240 containing received data for processing and the classification assigned to that data. For example, NIC 206 may communicate information identifying one or more receive buffers 242A, 242B . . . 242N containing data that has been segregated into classes by filers 208A, 208B . . . 208N.

In the embodiment illustrated, data may be indicated in a fashion that gives preference to data associated with higher priority classes. Accordingly, at block 330, the highest priority queue for which data was transferred may be selected. Any suitable mechanism may be used to identify a queue meeting the selection criteria. For example, memory 218 may store an indication of the priority with each of the receive queues 202A, 202B . . . 202N and may also contain counters or other data structures that identify the number of packets transferred from each queue. Control logic 210 may use this information in memory 218 to select a queue at block 330.

Regardless of how a queue is selected at block 330, once a queue is selected, processing proceeds to block 332. At block 332, data in the selected queue is indicated to stack 220 or other component within operating system 216 that is to process the data.

The process then proceeds to decision block 334. The process branches at decision block 334 depending on whether data from more receive queues has been transferred to the receive buffers and remains to be indicated. If so, the process branches to block 330 where the next highest priority queue is selected. Data in the selected class may then be indicated at block 332. The process may continue in this fashion until all relevant data is indicated. When data in multiple classes needs to be indicated, NIC 206 may indicate the data in multiple classes in response to one call. Alternatively, NIC 206 may indicate data in multiple classes in separate calls. Accordingly, the specific mechanism by which data in multiple classes is indicated is not a limitation on the invention.

As data is transferred, processing within subprocess 304 may analyze the data. That processing may include analysis at block 340 of the characteristics of packets received. In the embodiment illustrated, processing at block 340 monitors the number of packets of each class received. However, the specific processing performed at block 340 may depend on the nature of the applications executed by networked computer 104 and adjustments that can be made to the processing of received packets to alter the performance of networked computer 104.

For example, if processing at block 340 reveals that an application performing time critical functions is receiving a large volume of data, a higher priority may be assigned to the class that contains packets destined for that application. As another example, if processing at block 340 reveals a large number of SYN packets are received, the possibility of SYN attack may be identified. In response, the priority associated with the class containing SYN packets may be reduced. Alternatively, the NIC 206 may be reprogrammed to temporarily block or limited the number of SYN packets processed.

The process branches at decision block 342 based on the result of the analysis of received packet statistics performed at block 340. If the analysis at block 340 identifies a reconfiguration of NIC 206 that may improve performance, the process may branch to block 310 where subprocess 301 for configuring the NIC is repeated. Conversely, if processing at block 340 indicates that no reconfiguration is required, the processing may loop back to subprocess 302 where further packets are received. Processing may continue in this fashion with packets being received, classified, and transferred to system memory for further processing, with analysis of the received packets being performed to modify the configuration of the NIC for performance reasons.

FIG. 3 illustrates subprocesses 301, 302, 303 and 304 being performed sequentially. The subprocesses are depicted in this fashion for simplicity of illustration. In some scenarios, the subprocesses may be performed in different orders than pictured or may be performed in parallel. For example, NIC 206 may be reconfigured in subprocess 301 while packets are being received in subprocess 302. Likewise, packets may be transferred in subprocess 303 while packets are being received in subprocess 302. Similarly, review of statistics on received packets in subprocess 304 may occur at any suitable time, which could include the times during which subprocesses 301, 302 or 303 are being performed.

Though many of the processing depicted in FIG. 3 is performed within NIC 206, the location at which the processing is performed is also not a limitation on the invention. For example, processing at block 340 could be performed within control logic 210 based on data stored in NIC 206. Alternatively, statistical analysis could be performed by operating system 216 based on packet data as it is stored in receive buffers 242A, 242B . . . 242N. Alternatively or additionally, the review of statistics on received packets could be performed outside of networked computer 104 entirely and could be performed even when networked computer 104 is not in operation. Accordingly, the specific processing resources used to perform each of the subprocesses 301, 302, 303 and 304 is not a limitation on the invention and any suitable processing resources may be used. Likewise, the times at which subprocesses 301, 302, 303 and 304 are performed is not a limitation on the invention and the subprocesses may be performed at any suitable time.

Turning to FIG. 4, additional details of subprocess 302, representing processing of received packets, are illustrated. Subprocess 302 begins at block 410. At block 410, a packet is received. The manner in which a packet is received may depend on the physical construction of NIC 206 and the characteristics of network 102. Consequently, any suitable mechanism for receiving a packet may be employed. As an example, a receive module 212 as known in the art may be used to receive a packet. Upon receipt, the packet may be buffered or otherwise held temporarily for processing.

Regardless of how a packet is received, subprocess 302 continues to subprocess 420 during which the received packet is applied to one of the filters 208A, 208B . . . 208N (FIG. 2) to identify a class to which the packet belongs. In the embodiment depicted in FIG. 4, the received packet is shown applied to each of the filters sequentially. Sequential processing is shown for simplicity of illustration. NIC 206 may be implemented to allow processing in multiple filters simultaneously.

Subprocess 420 begins at block 422. In block 422, bits in the header of the received packet are selected for comparison to a pattern. As described above, each classification filter may be programmed by specifying selected bits in terms of a header, header offset, length and pattern bitmap. However, any suitable method for identifying and selecting bits in a packet for use in classifying packets may be employed.

Regardless of how the bits in a packet are selected, once selected the process proceeds to block 424. At block 424, the selected bits are compared to a pattern programmed for the filter. As described above, a pattern for each filter may be specified as part of programming NIC 206. However, any suitable mechanism may be used to define the pattern for the filter. Regardless of how the pattern is specified, a comparison operation is performed between the bits selected at block 422 and the pattern programmed for the filter.

Any suitable comparison operation may be used at block 424. In the embodiment of FIG. 2, the comparison operation used by each filter is determined based on programming of classification parameters for that filter. For example, a filter may be programmed to deem a received packet to be within its associated class if the selected bits match the programmed pattern for the filter. Alternatively, the filter may be programmed to classify a packet as belonging to its class when the selected bits do not match the pattern or the selected bits are within a range defined by the pattern.

Regardless of the specific comparison operation performed at block 424, the process proceeds to decision block 426. At decision block 426, the process branches depending on whether the selected bits meet the criteria in accordance with the comparison operation performed at block 424. If the selected bits do not meet the criteria, the process branches to decision block 450. At decision block 450, the process again branches depending on whether there are further filters to which the received packet may be applied. If more filters remain, the process branches back to block 422 where subprocess 420 begins again within another filter. The processing defined by blocks 422 and 424 and decision blocks 426 and 450 may be repeated until the received packet either meets criteria for a filter, as determined at decision block 426, or no more filters remain, as determined by decision block 450.

If the received packet has been processed in all filters without meeting the criteria of any filter, processing branches from decision block 450 to block 452. Block 452 represents default processing for a packet that does not meet the criteria of any filter and is therefore not assigned to any class. At block 452, the received packet is stored in a default queue. Because the packets stored at block 452 are not assigned to any class, they may be processed as in a networked computer as is known in the art which traditionally process packets that are not processed.

Conversely, if a received packet meets the criteria for the filter as determined at decision block 426, the process proceeds to decision block 428 where one or more actions may be performed based on programming of NIC 206. If NIC 206 has been programmed to drop packets of the class associated with the filter, the process branches to block 442 where the packet is dropped, completing processing of the packet.

Conversely, if NIC 206 is not programmed to drop packets meeting the filter criteria, processing proceeds to decision block 430. At decision block 430, the process branched depending on whether NIC 206 is programmed to limit the number of packets meeting the filter criteria that are processed. If NIC 206 is not programmed to limit the number of packets, processing proceeds directly to block 444. At block 444, the received packet is stored in the queue associated with the filter.

Once a packet is stored in a receive queue, it may be thereafter transferred to a receive buffer such as a buffer 242A, 242B . . . 242N (FIG. 2) associated with a class to which a packet has been assigned. Accordingly, processing proceeds from block 444 to block 460 at which packets are transferred from the receive queues 202A, 202B . . . 202N to system memory 240 (FIG. 2). Control logic 210 may be programmed with a destination for received data of each class. IN the embodiment illustrated in FIG. 2, data from each class is transferred to a corresponding one of the receive buffers 242A, 242B . . . 242N (FIG. 2). This transfer may be made as part of a DMA operation, though any suitable mechanism to transfer data may be used.

Similarly, if a packet is stored in a default queue in block 452, processing continues to block 460, where the packet is also transferred.

Conversely, if NIC 206 is programmed to limit the number of packets of the class being processed in subprocess 420, processing proceeds to decision block 432. At decision block 432, the processing again branches depending on whether the programmed limit has been exceeded. If the limit is exceeded, processing proceeds to block 442 where the packet is simply dropped, completing processing for that received packet. Conversely, if the limit is not exceeded, the process continues to block 444 where the received packet is stored in a receive queue associated with the class.

In this way, each received packet may be classified and then dropped or stored in a separate queue appropriate for packets of that classification. As a default, if the packet cannot be classified, it may be stored in a default queue for further processing. In this way, NIC 206 may be programmed to classify received packets to reduce processing performed in operating system 216 (FIG. 2). Alternatively or additionally, the classification may be used to implement functions that allocate processing resources more efficiently or protect networked computer 104 from certain forms of denial of services attacks.

Having thus described several aspects of at least one embodiment of this invention, it is to be appreciated that various alterations, modifications, and improvements will readily occur to those skilled in the art.

For example, in the foregoing embodiments, the network interface is controlled by the network stack within the operating system. There is no requirement that control be provided through the network stack and control may be provided by any suitable operating system component. Moreover, it is not necessary that control of the network interface be provided by a component within the operating system. Accordingly, the specific mechanism that programs or otherwise controls processing of received packets within the network interface is not a limitation of the invention.

Also, in the embodiments illustrated, each classification filter 208A, 208B . . . 208N outputs packets of a single class. It is not necessary that a classification be assigned based on processing in a single component. Packets may be classified based on sequential processing in multiple components. Further, the outputs of multiple filters or components may be aggregated to identify packets within a class. Accordingly, classification filters may be constructed with any of a number of combinations of hardware and software components.

Also, the invention was described using a client computer as an example. The invention may be employed in a server or any other type of networked computer. Accordingly, the type of computer is not a limitation on the invention.

Further, the invention was described as processing packets. The format of the received data is not a limitation of the invention. Further, a packet may contain formatting information, routing information or other information not used in all stages of processing. Accordingly, descriptions of storing, transferring or otherwise processing packets should be understood to include only data portions of the packets or only so much the packet as is used in subsequent processing.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A network interface adapted for connecting a computer system to a network to enable the computer system to receive a packet over the network, the packet having at least one characteristic, the network interface comprising:
a) a plurality of queues;
b) configurable control circuitry adapted to transfer the packet to a selected queue of the plurality of queues based on the at least one characteristic of the packet and a configuration of the control circuitry, the configuration based on at least one configuration command; and
c) an interface adapted to receive the at least one configuration command.

2. The network interface of claim 1, wherein the network interface comprises a network interface card and computer-readable medium encoding a driver adapted to control the network interface card.

3. The network interface of claim 2, wherein the network interface card comprises memory and each of the plurality of queues comprises a portion of the memory configured in response to at least one queue configuration command received through the interface.

4. The network interface of claim 1 in combination with a computer system, the computer system having an operating system adapted to provide the at least one configuration command.

5. The network interface in the combination of claim 4, further comprising a second interface between the network interface and the operating system, the second interface adapted to separately indicate to the operating system packets in each of the plurality of queues.

6. The network interface in the combination of claim 5, wherein the operating system is adapted to separately process the packets in each of the plurality of queues.

7. A method of operating a network interface having a plurality of receive resources, the network interface being coupled to a network, the method comprising:
a) receiving at least one configuration command;
b) receiving a packet over the network, the packet having at least one characteristic;
c) storing the packet in a resource of the plurality of resources, the resource selected at least in part based on the at least one configuration command and the at least one characteristic of the packet.

8. The method of claim 7, wherein the at least one characteristic is a packet type.

9. The method of claim 8, further comprising:
d) configuring the plurality of receive resources into a plurality of receive queues and wherein storing the packet comprises storing the packet into a selected queue of the plurality of receive queues, the selected queue selected based on the packet type.

10. The method of claim 7, further comprising:
d) configuring the plurality of receive resources into a plurality of receive queues, each receive queue associated with a packet type; and
e) receiving a plurality of packets, each of the plurality of packets having a type and storing each of the plurality of packets in a queue based on the type of the packet and the type associated with the queue.

11. The method of claim 10, wherein a first queue of the plurality of queues is associated with a packet type of SYN and a second queue of the plurality of queues is associated with a packet type of ACK.

12. The method of claim 7, wherein the network interface comprises a portion of a computer system having an operating system and receiving at least one configuration command comprises receiving at least one configuration command generated by the operating system.

13. The method of claim 12, wherein storing the packet comprises storing the packet in the resource when the packet meets criteria specified in the at least one configuration command and dropping the packet when the packet does not meet criteria specified in the at least one configuration command.

14. The method of claim 12, wherein the operating system accesses data stored in system memory and receiving at least one configuration command comprises receiving at least one command defining a location in the system memory and at least one class of packets to be stored in the defined location.

15. A method of operating a network interface in a computer system, the computer system having a computer-readable medium encoded with network software, the method comprising:
a) receiving with the network interface a plurality of packets, each packet having a type;
b) grouping at least a portion of the plurality of packets into groups based on the type of the packets; and
c) indicating to the network software the groups of received packets based on type.

16. The method of claim 15, further comprising:
d) configuring a plurality of receive resources on the network interface in response to at least one configuration command from the network software, the plurality of receive resources being configured into a plurality of queues.

17. The method of claim 16, wherein grouping at least a portion of the plurality of packets comprises storing the packets in queues based on the type of the packet.

18. The method of claim 17, further comprising:
e) detecting a volume of received packets of a type, the volume being characteristic of a denial of service attack; and
f) reconfiguring the receive resources to reduce the amount of receive resources allocated to a queue configured for storing packets of the type.

19. The method of claim 15, further comprising:
d) detecting a volume of received packets of a type, the volume being characteristic of a denial of service attack; and
e) within the network software, dropping at least a portion of the received packets of the type.

20. The method of claim 15, further comprising:
d) within the network software, processing indicated packets without analyzing the content of the packets to determine the type of the indicated packets.
